(19) United States
(12) Patent Application Publication
(10) Pub. No.: US 2021/0110382 A1
(43) Pub. Date: Apr. 15, 2021

(54) SYSTEM AND METHOD FOR PROVIDING AUXILIARY CURVE COLD STORAGE

(71) Applicant: MobileCoin, San Francisco, CA (US)

(72) Inventors: Robb WALTERS, San Francisco, CA (US); Joseph YANDLE, San Francisco, CA (US); Isis Agora LOVECRUFT, San Francisco, CA (US); Isaac Michael Lang SWANLUND, Lake Elmo, MN (US)

(21) Appl. No.: 17/069,033

(22) Filed: Oct. 13, 2020

Related U.S. Application Data
(60) Provisional application No. 62/914,504, filed on Oct. 13, 2019.

(51) Int. Cl. G06Q 20/36; G06Q 20/38; H04L 9/06; H04L 9/08

(52) U.S. Cl. CPC G06Q 20/3674; G06Q 20/3823; G06Q 20/3827; H04L 9/0897; H04L 9/0643; H04L 9/0825; H04L 9/0877; G06Q 20/3829

(57) ABSTRACT

A system and method for providing auxiliary curve cold storage are disclosed. A particular embodiment can be configured to: prepare a base cryptocurrency protocol transaction in a secure transaction network including a consensus network, a ledger, and a network node in data communication with the consensus network, the ledger, and other network nodes in the secure transaction network via a data network; generate a transaction output signature (txo-sig) by signing a hash of a source transaction output (source-txo) with a certified hardware security module (HSM) private key; submit the base cryptocurrency protocol transaction and the txo-sig to the consensus network via the network node of the secure transaction network as a deposit transaction; create a ristretto point (rptxo) from a hash of an HSM public key, the source-txo, and the txo-sig; and replace the source-txo with the ristretto point (rptxo) in the ledger of the secure transaction network.

### PRIORITY PATENT APPLICATION

This non-provisional patent application draws priority from U.S. provisional patent application Ser. No. 62/914,504; filed Oct. 13, 2019. This present non-provisional patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2017-2020, MobileCoin, Inc., All Rights Reserved.

### TECHNICAL FIELD

This patent document pertains generally to secure transaction networks, online payment systems, secure online digital delivery systems, and more particularly, but not by way of limitation, to a system and method for providing auxiliary curve cold storage.

### BACKGROUND

To support custodianship at leading cryptocurrency exchanges, the exchange must support the delegation of spending authority to a FIPS 140 certified hardware security module (HSM) for funds moved to “cold storage.” FIPS 140 is a Federal Information Processing Standard (FIPS) Publication No. 140, which is a publicly-available U.S. government computer security standard used to approve and certify cryptographic modules and HSMs. Exchanges commonly require cold storage for digital assets to satisfy insurance and regulatory oversight requirements.

A cryptocurrency that does not support cold storage using a certified HSM device may have substantially less utility or market appeal.

Typical HSM devices are designed to support the cryptographic curves and algorithms that are recommended for government use. The set of recommended cryptographic curves for Elliptic Curve Digital Signature Algorithm (ECDSA) digital signatures is described in FIPS Publication No. 186. Exchanges currently offer custodianship services for Bitcoin™ and other cryptocurrencies, which rely on digital signatures that use the “secp256k1” curve. This curve does not appear on the list of recommended curves, suggesting that acceptable HSM devices could also be developed for other curve systems. However, it may be prohibitively expensive and time consuming to produce and certify new HSM devices with support for other curve systems. An alternative solution would be to modify a currently used cryptocurrency protocol to use curves and algorithms that are available on existing certified HSM hardware. However, these changes would be costly and time-consuming to implement and would compromise performance. It would be advantageous to provide a method for delegating spending authority to a certified HSM suitable for cryptocurrencies that require algorithms that are not available on certified HSM hardware.

### SUMMARY

A system and method for providing auxiliary curve cold storage are disclosed. In the various example embodiments disclosed herein, the auxiliary curve cold storage system of an example embodiment introduces a second layer of cryptography on top of a currently used cryptocurrency protocol for “cold storage” transactions. This allows spending authority to be selectively controlled by signing algorithms that are compatible with certified HSM devices, without modifying the protocol for other transactions.

The various example embodiments disclosed herein are not limited to cryptocurrencies that make use of SGX, the Stellar Consensus Protocol algorithm, or those that implement parts of the CryptoNote protocol. SGX is an Intel® Corporation Software Guard Extensions (SGX) architecture. SGX is a set of central processing unit instruction code from Intel® that allows user-level code to allocate private regions of memory, called enclaves, which are protected from processes running at higher privilege levels. The Stellar Consensus Protocol (SCP) provides a way to reach consensus in a secure financial transaction without relying on a closed system to accurately record financial transactions. CryptoNote is an application layer protocol that aims to solve the problems outlined in Bitcoin™ Core, the protocol behind Bitcoin™ The protocol powers several decentralized privacy-oriented cryptocurrencies.

The various example embodiments disclosed herein can be used to enable custodial management of or with other cryptocurrencies, which use cryptographic curves that are not approved by the National Institute of Standards and Technology (NIST), a non-regulatory agency of the United States Department of Commerce. For example, the various example embodiments disclosed herein can be used to enable custodial management for Stellar Lumens™, Zcash™ Sia™, Scorex™, BigchainDB™, Chain Core™, and Monero™, among others. In each case, changes to the code that validates transactions may need to be adopted.

The additional layer of encryption of the example embodiment is applied using three new transactions types: 1) Cold Storage Deposit, 2) Cold Storage Withdrawal, and 3) Cold Storage Transfer. These three transaction types of the auxiliary curve cold storage system of an example embodiment are described in more detail below with reference to the figures provided herewith.

### BRIEF DESCRIPTION OF THE DRAWINGS

The various embodiments are illustrated by way of example, and not by way of limitation, in the figures of the accompanying drawings in which:

FIG. 1 illustrates an example of a standard Cryptonote transaction in which an example embodiment disclosed herein can be implemented;

FIGS. 2 through 4 illustrate close-up views of portions of the example standard Cryptonote transaction shown in FIG. 1;

FIG. 5 illustrates an example embodiment showing how each output key is signed by the certified hardware security module (HSM);

FIG. 6 illustrates an example embodiment showing how a cold storage transaction causes signatures to be published in place of transaction output public keys in the ledger;

FIG. 7 illustrates an example embodiment showing how a withdrawal transaction can match the public key from the same HSM used for signatures published in the deposit;

FIG. 8 illustrates an example embodiment showing how a withdrawal transaction will not match the public key from a different HSM;

FIG. 9 illustrates an example embodiment of a secure transaction network ecosystem in which an example embodiment can be implemented; and

FIG. 10 is a processing flow chart illustrating an example embodiment of a system and method for providing auxiliary curve cold storage.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A system and method for providing auxiliary curve cold storage are disclosed. In the various example embodiments disclosed herein, the auxiliary curve cold storage system of an example embodiment introduces a second layer of cryptography on top of a currently used cryptocurrency protocol for “cold storage” transactions. This allows spending authority to be selectively controlled by signing algorithms that are compatible with certified HSM devices, without modifying the protocol for other transactions.

The additional layer of encryption of the example embodiment is applied using three new transactions types: 1) Cold Storage Deposit, 2) Cold Storage Withdrawal, and 3) Cold Storage Transfer. These three transaction types of the example embodiment are described in more detail below with reference to the figures provided herewith.

### Cold Storage Deposit

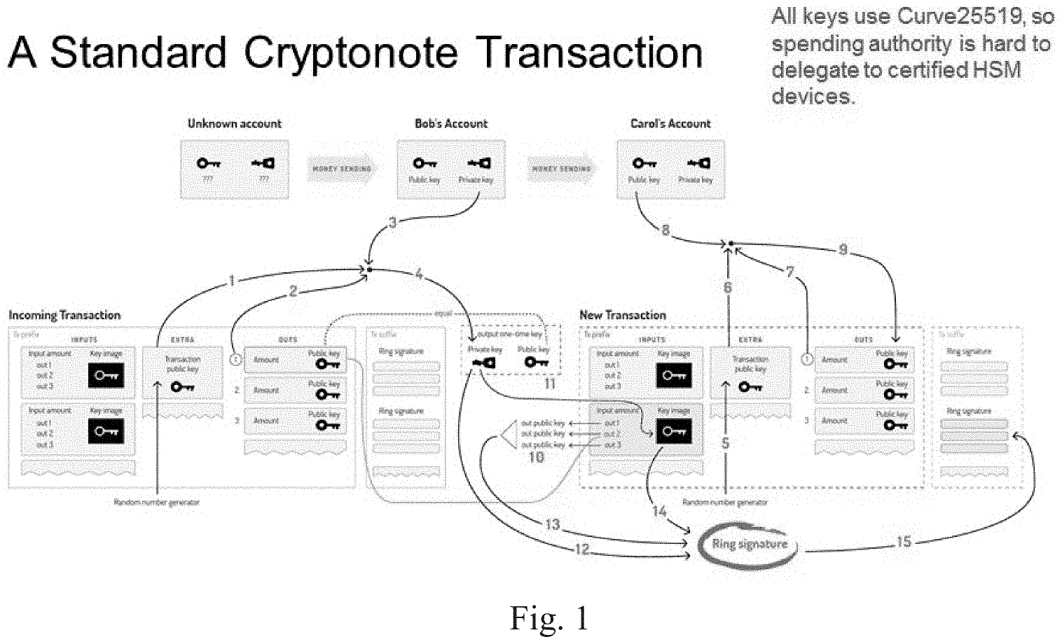

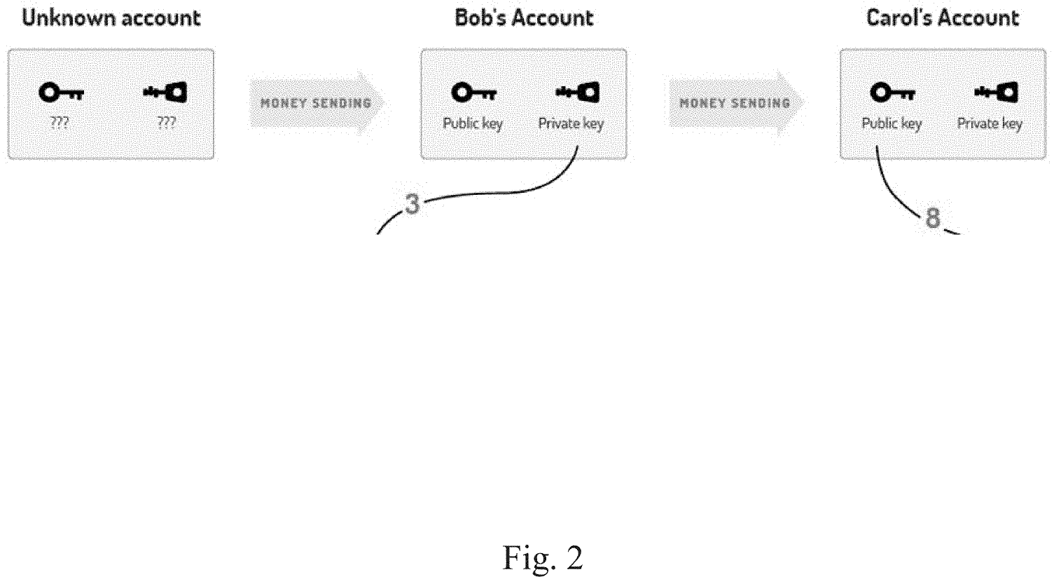

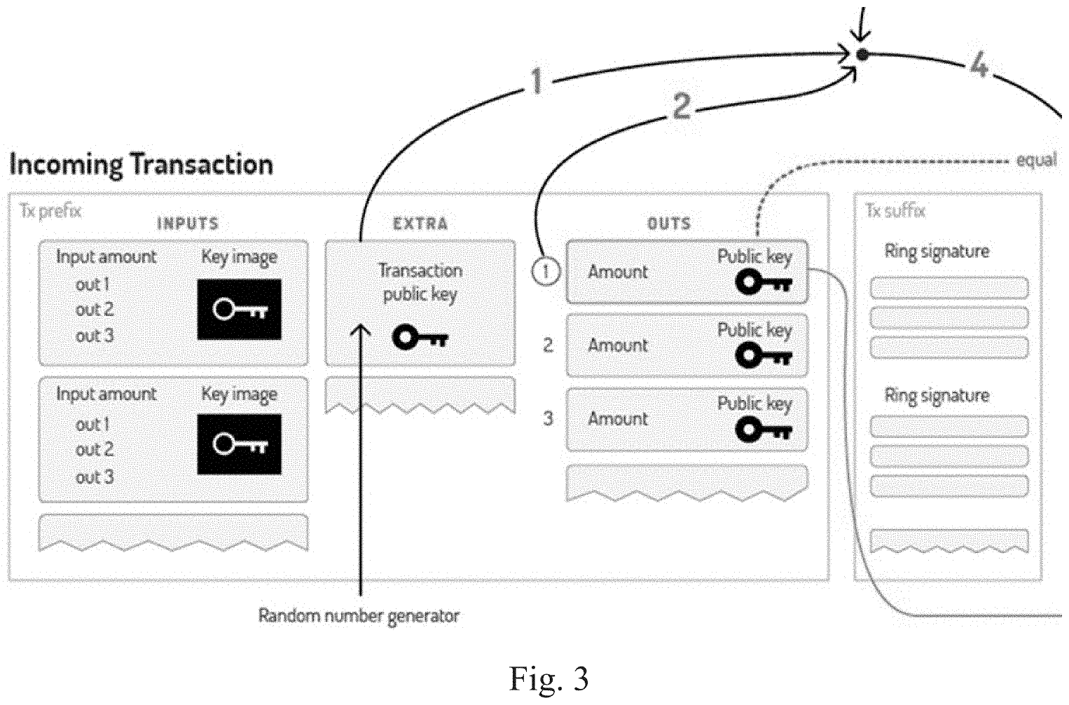

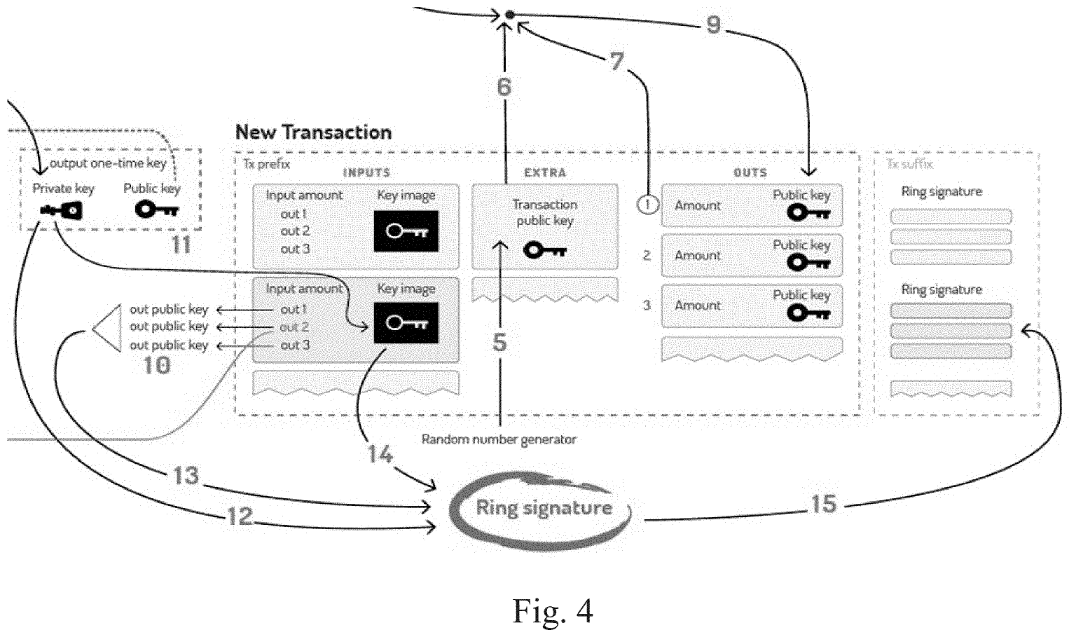

FIG. 1 illustrates an example of a standard Cryptonote transaction in which an example embodiment disclosed herein can be implemented. FIGS. 2 through 4 illustrate close-up views of portions of the example standard Cryptonote transaction shown in FIG. 1. Referring now to FIGS. 1 through 4, to move funds from an unspent transaction output (utxo) to cold storage, a client device using a software development kit (SDK), supporting an example embodiment disclosed herein, first prepares a base Cryptonote transaction (or other cryptocurrency protocol transaction), complete with ring signatures, fees, Merkle proofs, bulletproofs, etc. using, for example, a Curve25519-based construction and Cryptonote keys stored outside of the HSM. An example of a standard Cryptonote transaction is shown in FIGS. 1 through 4. A full disclosure of a particular embodiment using a secure transaction network and Merkle proofs is described in MobileCoin, Inc. U.S. patent applications with application Ser. No. 16/213,956, filed Dec. 7, 2018 and titled, “SYSTEM AND METHOD FOR PROVIDING A SECURE TRANSACTION NETWORK”; and application Ser. No. 16/570,675, filed Sep. 13, 2019 and titled, “SYSTEM AND METHOD FOR PROVIDING PRIVACY-PRESERVING PROOFS OF MEMBERSHIP.” The entire disclosure of the referenced patent applications is considered part of the disclosure of the present application and is hereby incorporated by reference herein in its entirety.

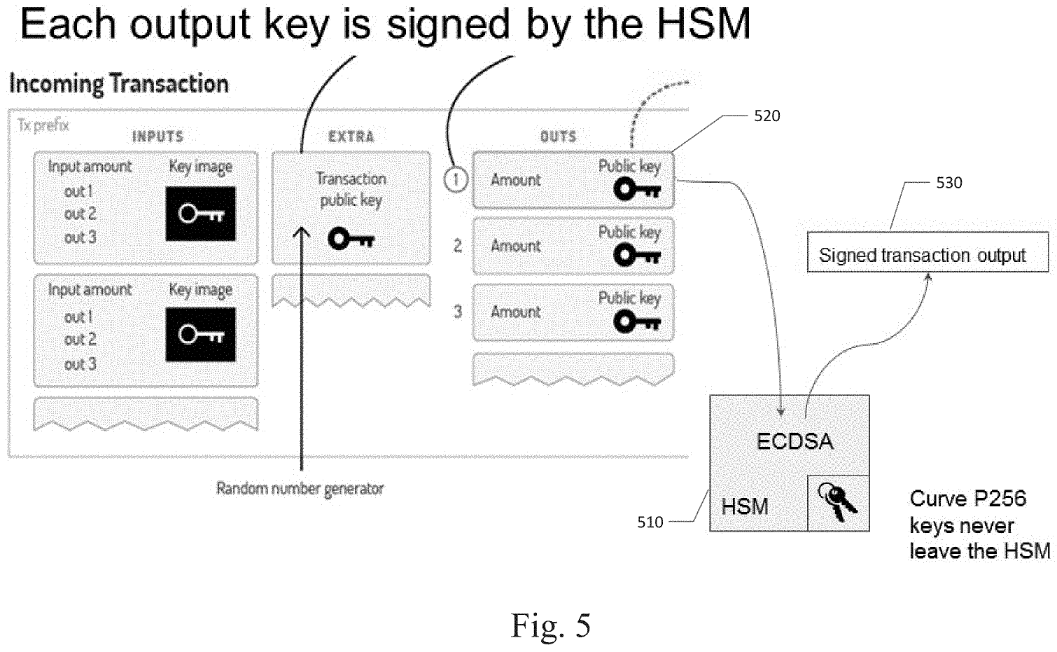

FIG. 5 illustrates an example embodiment showing how each output key is signed by the certified hardware security module (HSM). Referring now to FIG. 5, after the base transaction is prepared as described above, the transaction output to be moved to cold storage (the “source-txo”) is processed using the HSM 510 to generate a transaction output signature (txo-sig) 530 by signing the hash of the source-txo 520 with the HSM 510 private key. Note that the ECDSA keypair never leaves the HSM 510.

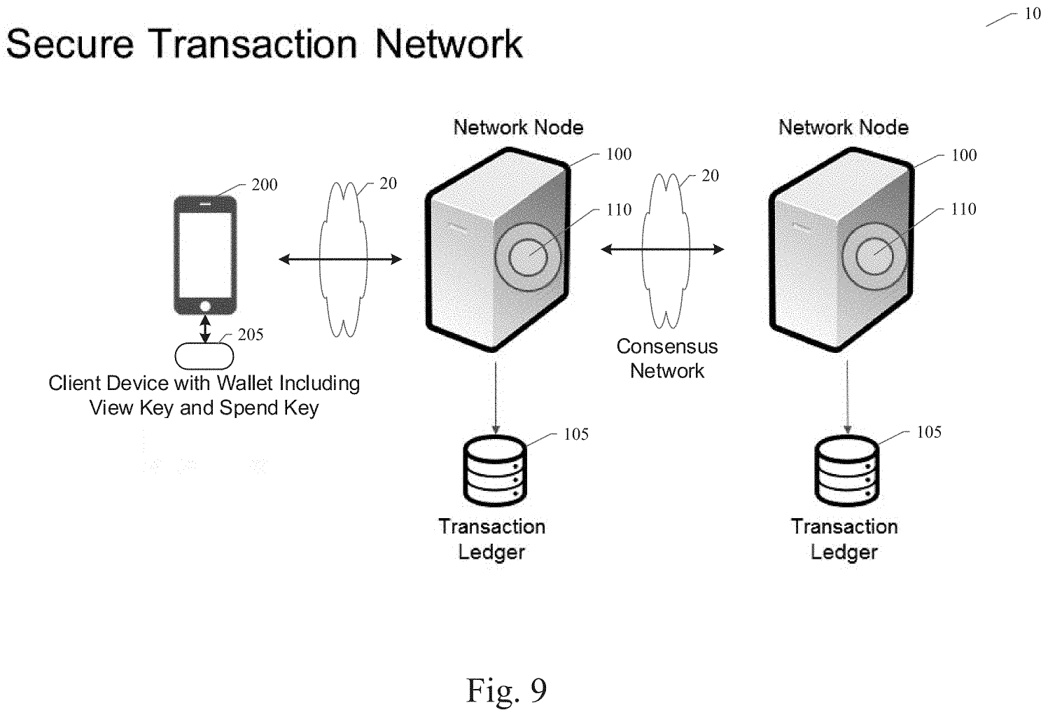

The base Cryptonote transaction and the txo-sig are submitted together to the consensus network via secure network nodes of a secure transaction network as a deposit transaction. The validity of the base transaction is first checked as in a standard transaction submitted to the secure transaction network and the consensus network. In an example embodiment, the network nodes of the secure transaction network can also include an internal secure computing environment or enclave. The enclave represents a secure computing environment having: 1) an encrypted, isolated, and/or sequestered memory (e.g., random access memory or RAM); 2) isolated processing logic that cannot make or receive calls from an operating system (OS); and 3) an ability to attest to the authenticity and security of the secure computing environment upon request from a client device or another network node. In a particular example embodiment, the enclave can be implemented as an ^{Intel}® Corporation SGX architecture as described above. In the network nodes with SGX enclaves of the particular example embodiment, the network nodes are configured to run with an SGX secure enclave. The SGX enclave is isolated from the host operating system (OS) in hardware-encrypted random access memory (RAM), which prevents the network node operator from having access into the enclave. An example embodiment of a secure transaction network ecosystem in which an example embodiment can be implemented is described below in connection with FIG. 9.

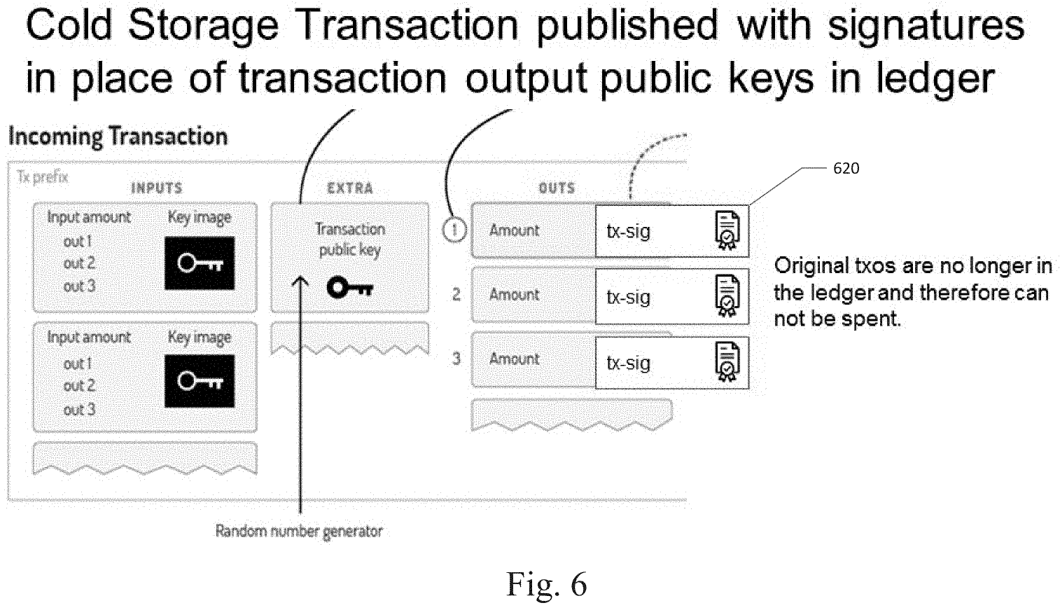

FIG. 6 illustrates an example embodiment showing how a cold storage transaction causes signatures to be published in place of transaction output public keys in the ledger. Referring now to FIG. 6, once the validity of the base transaction is checked and confirmed, the enclave of the network node can then create a ristretto point (rptxo) from the hash of the ECDSA public key, source-txo, and txo-sig. Ristretto is a construction of a prime-order group using a non-prime-order Edwards curve. Edwards curves are a family of elliptic curves widely used in elliptic curve cryptography. When the deposit transaction is externalized to the public ledger, the consensus enclave replaces the source-txo with the derived ristretto point (rptxo) 620. The original source-txo is no longer included in the public ledger, and therefore is incapable of being spent.

For any rptxo, there will be a corresponding private key that advances the generator point by application of the group operator to the rptxo value. It is very important that we do not use an algorithm that leaks this private key when we calculate the rptxo. Moreover, there are a few other possible implementation options:
a) Generate a random 32 byte hash value, and then increment the resulting value until we find a curve point. The first valid curve point greater than the hash of the txo-sig is the desired rptxo.
b) Use the hash-to-point algorithm described as part of a known XEdDSA signature scheme, taking care that the implementation does not leak the private key corresponding to the resulting curve point. XEdDSA is used to create and verify EdDSA-compatible signatures using public key and private key formats initially defined for the X25519 and X448 elliptic curve Diffie-Hellman functions. XEdDSA enables use of a single key pair format for both elliptic curve Diffie-Hellman and signatures. In some situations it enables using the same key pair for both algorithms.
c) Add consecutive integers to the hash function input and re-hash until we arrive at a curve point by chance.

Following this procedure, the rptxo will look like a standard transaction output (i.e., a 32 byte random location on the ristretto curve), maintaining zero knowledge privacy in the public data. Cold storage transactions are therefore computationally indistinguishable from other transactions. That is, given any practical computation resources, a cold storage transaction cannot be identified in the public ledger with a probability better than random guessing.

It may not be necessary to obscure which transactions are in cold storage. In this case, we do not need to generate the rptxo value. Instead all authorization data can be published to the blockchain in a unique field.

We note that the hint field of the transaction may be safely used to store the original source-txo value for convenience, using additional random data to pad its value to any desired length.

### Cold Storage Withdrawal

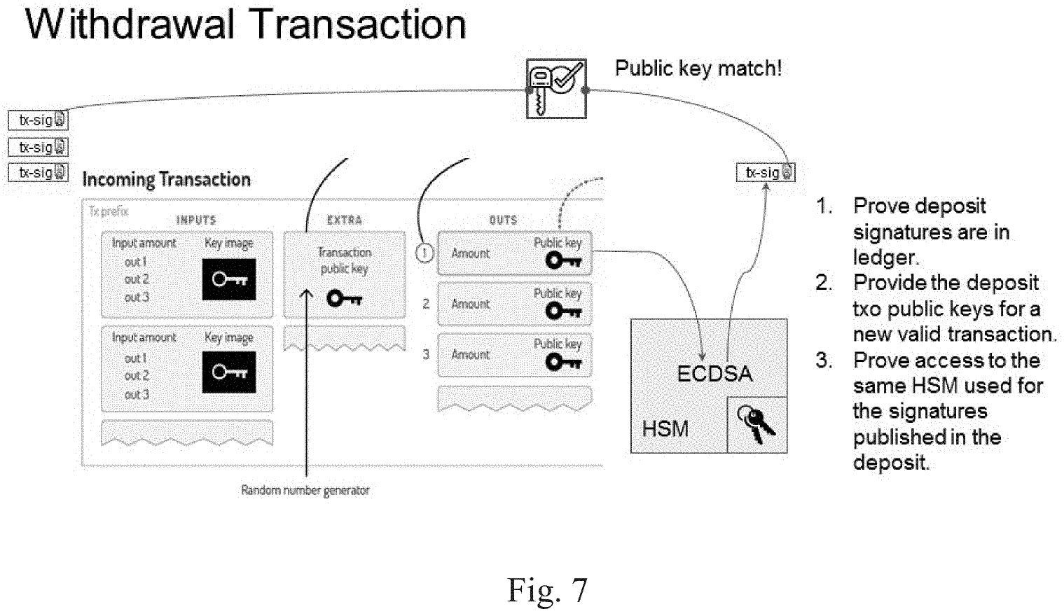

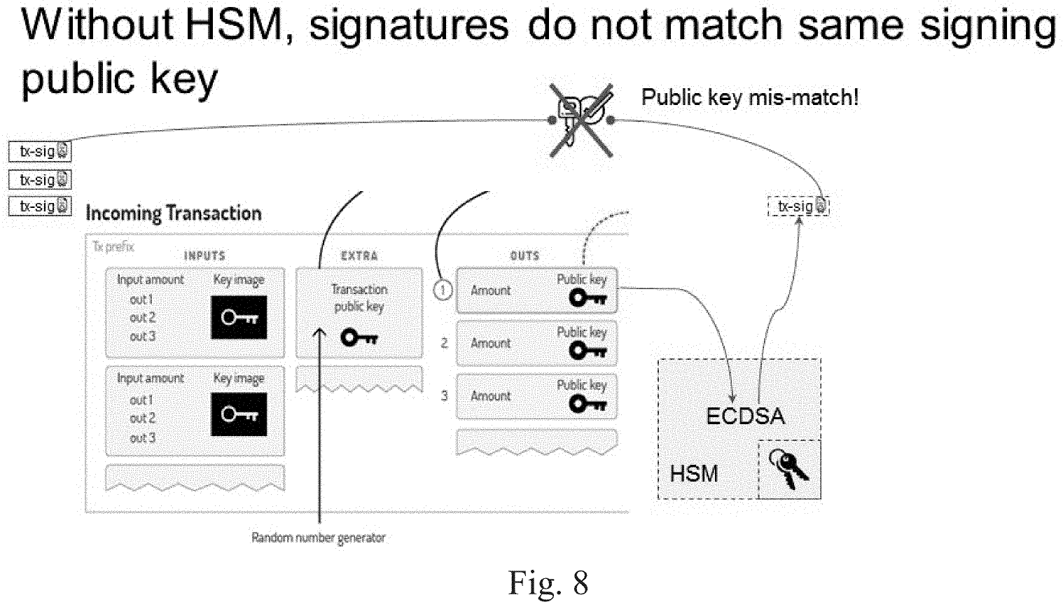

FIG. 7 illustrates an example embodiment showing how a withdrawal transaction can match the public key from the same HSM used for signatures published in the deposit. FIG. 8 illustrates an example embodiment showing how a withdrawal transaction will not match the public key from a different HSM. Referring now to FIGS. 7 and 8, to move value out of “on chain cold storage”, we first recover the corresponding source-txo, either from the hint field or from off-chain storage. A withdrawal transaction is constructed, consisting of a base Cryptonote transaction (or other cryptocurrency protocol transaction), the original source-txo to be withdrawn, the rptxo that exists in the ledger and a Merkle proof of its existence in the ledger, the HSM public key, the new output txos, and a txo-sig signature over the new txo for each of the new output txos in the withdrawal transaction. As shown in FIG. 7, the consensus node is able to verify that the rptxo appears in the ledger, validate the ring signature, and confirm that the HSM used to sign the withdrawal matches the HSM used to sign the deposit. As shown in FIG. 8, it is never possible to move value out of cold storage without using the ECDSA keys from the same HSM used to sign the deposit.

### Cold Storage Transfer

To move value from one “on-chain cold storage” to another “on-chain cold storage” transaction without moving the funds out of cold storage as an intermediate step, the withdrawal transaction can be modified slightly to include a new output rptxo, and new output txo-sig.

### Example of a Secure Transaction Network Ecosystem

Referring now to FIG. 9, an example embodiment of a secure transaction network ecosystem 10 in which an example embodiment can be implemented is illustrated. As shown in

FIG. 9, the secure transaction network ecosystem 10 can include a plurality of distributed computing nodes or network nodes 100 in networked data communication with each other via network 20. The secure transaction network ecosystem 10 can also include a plurality of user or client platforms or client devices 200 in networked data communication with one or more of the network nodes 100 via network 20. Each client device 200 can include a wallet 205, which is a software component executing within the client device 200.

Network 20 can be configured to couple one computing device/node with another computing device/node in networked data communication. Network 20 may be enabled to employ any form of computer readable media for communicating information from one electronic device to another. For example, network 20 can include the Internet, other wide area networks (WANs), local area networks (LANs), direct connections, such as through a universal serial bus (USB) port, wireless data connections (e.g., WiFi, Bluetooth™, etc.), optic data connections, other forms of devices for the transfer of computer-readable media, or any combination thereof. On an interconnected set of sub-networks, including those based on differing architectures and protocols, a router and/or gateway device can act as a link between sub-networks, enabling messages to be sent between computing devices/nodes in a network ecosystem.

Network 20 may further include any of a variety of wireless sub-networks that may further overlay stand-alone or ad-hoc networks to provide an infrastructure-oriented connection. Such sub-networks may include mesh networks, wireless LAN (WLAN) networks, cellular networks, and the like. Network 20 may also include an autonomous system of terminals, gateways, routers, and the like connected by wireless radio links or wireless transceivers. These connectors may be configured to move freely and randomly and organize themselves arbitrarily, such that the topology of network 20 may change rapidly and arbitrarily.

Network 20 may further employ a plurality of access technologies including 2^{nd} (2G), 2.5, 3^{rd} (3G), 4^{th} (4G), 5^{th} (5G) generation network technologies, including radio access for cellular systems, WLAN, Wireless Router (WR) mesh, and the like. Access technologies such as 2G, 3G, 4G, 5G, and future access networks may enable wide area coverage for mobile devices, such as one or more of client devices 200, with various degrees of mobility. For example, network 20 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Network 20 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, network 20 may include virtually any wired and/or wireless data communication mechanisms by which information may travel between one computing device and another computing device, network, and the like.

Referring still to FIG. 9 for an example embodiment, a user or client platform represented as client device 200 can correspond to any type of client computing or communication device enabling a user to submit transaction requests or access transaction data provided by the secure transaction network 10 via the network 20. Client devices 200 may include virtually any computing device that is configured to send and receive information over a network, such as network 20. Such client devices 200 may include mobile or portable devices, such as, cellular telephones, smart phones, camera phones, display pagers, radio frequency (RF) devices, infrared (IR) devices, global positioning devices (GPS), Personal Digital Assistants (PDAs), handheld computers, wearable computers, tablet computers, Internet of Things (IoT) devices, integrated devices combining one or more of the preceding devices, and the like. The client devices 200 may also include other computing devices, such as personal computers (PCs), multiprocessor systems, microprocessor-based or programmable consumer electronics, network PC's, and the like. The client devices 200 may also include other processing devices, such as consumer electronic (CE) devices and/or embedded computing devices, which are known to those of ordinary skill in the art. As such, the client devices 200 may range widely in terms of capabilities, features, and resources. For example, a client device 200 configured as a basic cellphone may have a low-capability data processor, a numeric keypad and a few lines of monochrome LCD display on which only text may be displayed. In another example, a more sophisticated web-enabled client device 200 may have a more robust data processor, a higher level of memory resources, a touch sensitive screen, a stylus, and a full screen color LCD display in which both text and graphics may be displayed. Moreover, the web-enabled client device 200 may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, obile devices can be configured with applications (apps) with which the functionality described herein can be implemented.

The client device 200 may also include at least one client application that is configured to interact with the secure transaction network 10 via network 20. In an example embodiment, the client application can be a wallet 205 corresponding to a software module for execution by a data processor of the client device 200, the wallet 205 being configured to manage a user's digital cash and the secure transactions related thereto. In particular, the wallet 205 enables a user of a client device 200 to send and receive digital cash and related secure transactions via the secure transaction network 10.

Referring still to FIG. 9 for an example embodiment, the secure transaction network 10 can include a plurality of distributed computing nodes or network nodes 100 in networked data communication with each other and with client devices 200 via network 20. Each of the network nodes 100 can correspond to any type of secure computing device or secure computing environment enabling the secure processing of client transactions within the secure transaction network 10. In an example embodiment, network nodes 100 may include virtually any computing device that is configured to send and receive information over a network, such as network 20. Such network nodes 100 may include server computers, server farms, personal computers (PCs), PC arrays, multiprocessor systems, multi-computer systems, multiple core systems, microprocessor-based systems, single silicon wafer resident processors, multiple silicon wafer resident processors, quantum computing systems, and the like.

Each of the network nodes 100 of the secure transaction network 10 can include or be coupled with a transaction ledger 105 for storage of secure transaction data, key images, and related information. In an example embodiment, the transaction ledger 105 can be implemented as a secure data storage device, a database, a secure memory area or partition, or the like.

As shown in FIG. 9, the network nodes 100 of an example embodiment also include an internal secure computing environment or enclave 110. The enclave 110 represents a secure computing environment having: 1) an encrypted, isolated, and/or sequestered memory (e.g., random access memory or RAM); 2) isolated processing logic that cannot make or receive calls from an operating system (OS); and 3) an ability to attest to the authenticity and security of the secure computing environment upon request from a client device 200 or another network node 100. In a particular example embodiment, the enclave 110 can be implemented as an Intel® Corporation Software Guard Extensions (SGX) architecture. SGX is a set of central processing unit instruction code from Intel® that allows user-level code to allocate private regions of memory, called enclaves, which are protected from processes running at higher privilege levels. In the network nodes 100 with SGX enclaves 110 of the particular example embodiment, the network nodes 100 are configured to run with an SGX secure enclave 110. The SGX enclave 110 is isolated from the host OS in hardware-encrypted RAM, which prevents the network node 100 operator from having access into the enclave 110. SGX also supports a feature known as remote attestation, which allows a remote client or other external computing system to determine that a network node 100 is running a specific and authenticated software component inside an SGX enclave 110. The remote attestation can be performed over the network 20. By performing remote attestation of the enclaves 110 before establishing encrypted communication channels between network nodes 100, the entire transaction ledger 105 is configured to remain sealed within SGX enclaves 110 across the entire secure transaction network 10. As a result, the transaction ledger 105 can be distributed among all network nodes 100 of the secure transaction network 10; however, the contents of the transaction ledger 105 will never be accessible or viewable by humans, even the operators of the network nodes 100, as long as the SGX enclaves 110 and the secure transaction network 10 software remains secure. It will be apparent to those of ordinary skill in the art in view of the disclosure herein that secure enclaves 110 can be implemented with a secure computing environment other than Intel® SGX architecture.

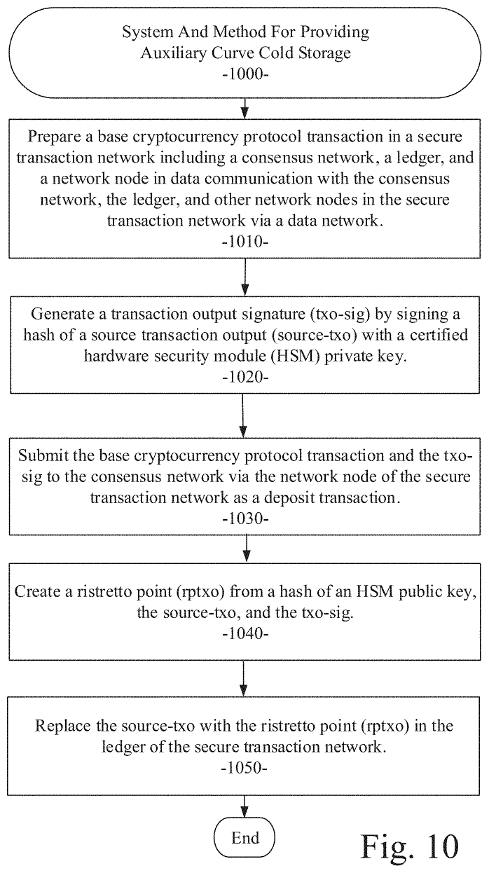

FIG. 10 is a processing flow diagram illustrating an example embodiment of the system and method for providing auxiliary curve cold storage as described herein. The method 1000 of an example embodiment includes: preparing a base cryptocurrency protocol transaction in a secure transaction network including a consensus network, a ledger, and a network node in data communication with the consensus network, the ledger, and other network nodes in the secure transaction network via a data network (processing block 1010); generating a transaction output signature (txo-sig) by signing a hash of a source transaction output (source-txo) with a certified hardware security module (HSM) private key (processing block 1020); submitting the base cryptocurrency protocol transaction and the txo-sig to the consensus network via the network node of the secure transaction network as a deposit transaction (processing block 1030); creating a ristretto point (rptxo) from a hash of an HSM public key, the source-txo, and the txo-sig (processing block 1040); and replacing the source-txo with the ristretto point (rptxo) in the ledger of the secure transaction network (processing block 1050).

### Dual-Curve Output Authorization

There are many situations where it is valuable to require authentication from public keys created on different curves for spending a cryptocurrency output. For example, “HSMs” (hardware security modules) are high-end, government-certified devices used to securely manage digital keys, and are staples of high-stakes environments. However, HSMs are only able to handle a limited number of cryptographic curves, and can't directly interact with cryptocurrencies that manage spend authority with curves outside that range.

By allowing cryptocurrency transaction authors to assign output spend authority to public keys from different curves, it is possible to expand signing rights to HSM devices without compromising the currency's core protocol. As described in detail below, we disclose embodiments of an extension to the class of cryptocurrency protocols known as “RingCT”, with a focus on a particular variant, which enables a unique kind of transaction output that can only be spent when two public keys from different curves authorize the transaction output.

### First Example Embodiment—Attached Secondary Address

As disclosed above, a dual-curve authentication procedure focused around cold storage is described. A user may ‘deposit money into cold storage’ with a normal self-spend transaction that includes a signature from an HSM public key. A self-spend transaction is one where the user sends money to themselves. In this case, the user needs both their normal wallet keys and their HSM public key to spend the money again. To withdraw that ‘cold storage’ money, the user can create another normal transaction spending the relevant output, and provide a second signature with the same HSM public key.

Importantly, the secure transaction network must verify both HSM signatures are legitimate. In the described example embodiments, an HSM signature is just a normal elliptic curve signature (e.g., ECDSA), using some elliptic curve supported by HSM devices. Protocol designers have to choose which HSM curve to use out of the available standard choices (e.g., a NIST standard curve).

Suppose an individual user wishes to deposit money (which they already own) into HSM-secured cold storage. The general steps the user would follow are set forth below:
1. Make a complete regular transaction. The regular transaction can have any number of inputs and outputs. Some subset of the outputs are intended to be in HSM-secured cold storage.
2. Compute a hash of the transaction and send that hash into the HSM, which signs the hash with the HSM public key (e.g., using ECDSA, or a similar signature process). If there are multiple outputs directed at HSM-secured cold storage, compute a unique HSM signature for each unique HSM public key (it is fine to reuse signatures for multiple outputs aimed at the same HSM key).
3. Submit the transaction, along with a list of pairings between output index and HSM signature (and HSM public key), to the secure transaction network.
   (a) Network nodes receiving the transaction must verify the transaction normally, and then also verify the HSM signature(s).
   (b) Once a transaction is verified, the node computers, for each output x intended for HSM cold storage, a hash-to-point of the one-time output address Kₓ^{o}, the HSM signature σₓ^{HSM}, and the HSM public kay Kₓ^{HSM}.

K_{Jake,x}^{o}= [symbol] ₚ(Kₓ^{o}, σₓ^{HSM}, Kₓ^{HSM})

(c) Store the fake output address K_{Jake,x}^{o} in place of the one-time output address.
(d) Either discard the original one-time address Kₓ^{o}, or place it in the ‘memo field’ for convenience (i.e. for identifying owned output that are in cold storage).

Now suppose that individual wants to withdraw money previously deposited into HSM-secured cold storage.
1. Recover the original one-time output addresses for all the outputs to be withdrawn from cold storage, either by looking in the ‘memo field’ or offline storage.
2. Make a normal transaction, spending an arbitrary number of owned outputs as inputs, and creating an arbitrary number of new outputs. Pause before signing the inputs.
3. Alongside the cold-storage inputs to this new transaction, add the real one-time output addresses Kₓ^{o}, the original HSM signatures σₓ^{HSM}, and the HSM. This way verifiers can check that the fake one-time addresses K_{Jake,x}^{o} were computed from the addresses that will sign this transaction.
4. Now the transaction can be signed. Inpute MLSAG signatures are computed nromally, using the real cold storage one-time output adressess where applicable. Each cold storage output being spent requires an additional HSM signatures with its HSM public key K9hd x^{HSM}, with the signed message being the entire transaction (the same messaged signed by MLSAGs). MLSAG is an acronym for “Multi-layered Linkable Spontaneous Anonymous Group,”
5. Submit this new transaction to the network. The new transaction includes, aside from standard transaction components, an HSM public key, old HSM signature, new HSM signature, and fake one-time output address for each HSM-secured cold-storage output being spent.
   (a) Network nodes verify the normal parts of the transaction.
   (b) They also verify both new and old HSM signatures, that the HSM key is the same in each pair, and that the fake one-time addresses can be reconstructed with

K_{fake, x}^{a}= [symbol] ₚ(Kₓ^{o}, σₓ^{HSM}, Kₓ^{HSM})

### First Example Embodiment—Drawbacks

There are a few drawbacks to the protocol just discussed.
1. Transactions sending money into cold storage must be signed. ‘Sign to deposit and withdraw’ is a significant narrowing of the standard requirement ‘sign to withdraw’.
2. There is no easy way to recover the real one-time output address of a cold storage output without giving hints to observers that it is in cold storage (e.g. by including the address in the ‘memo field’).
3. There is no straightforward way to incorporate the secondary authorization key into ring signatures, so when a cold storage output is withdrawn/spent it won't be obfuscated among decoys (even if an ML SAG is used on those inputs, observers will know which ring member is the real signer since the signing address has to be explicitly written in the transaction). If cold storage outputs are allowed to be decoys of other ring signatures, those ring signatures will be polluted by the impossible-to-hide outputs.
4. Every time a given secondary authorization key is used, it is guaranteed to be linkable to other uses of that key. In other words, there is no easy way to make one-time secondary authorization keys without generating completely new keys for each cold storage output.

### Second Example Embodiment—Output Off

Fortunately, many of the drawbacks of the protocol described above can be addressed, while also making the protocol changes more generic and less focused on HSMs and cold storage. An example of this second example embodiment is described in more detail below. Suppose an individual wishes to receive money to a dual-key account. This account has a normal RingCT address (K^{el,x}, K^{el,x}) (view and spend keys), and secondary authorization address Kₐᵤₜₕ^{c2}=k^{c2}*G^{c2}. We use superscripts c1 and c2 to denote keys on two different elliptie curves. Curve 1 is the core curve employed by the RingCT-based cryptocurrency under consideration, and curve 2 is some other (secure and robust)elliptie curve.

A different individual, the sender, can send money to the dual-key account with the following procedure.
1. Assemble a normal transaction, with an arbitrary number of inputs and outputs of any type.
2. If output t is being sent to a dual-key address, compute a normal one-time address Lₜ^{c1,o} from its curve 1 address. Then compute a dual-key offset like this (do for ‘dual-key offset’, with a hash-to-point function [symbol] ₚ( ) that produces points in curve 1):

Kₜ^{x1,da}= [symbol] ₚ(K_{auth,3}^{x2,xh})

Here K_{base,2}^{x2} is the base key of K_{auth,x}^{c2,xh}, which is a Diffie-Hellman shared key between the base key and the secondary authorization address. The base key can either be the second curve's generator G^{c2} (in which case the shared key is equal to the secondary authorization key), or based on the sender-reciver shared secret. As we will see, using the sender-receiver shared secret allows the recipient to hide their secondary key from verifiers when spending dual-key outputs. It uses a hash-to-sealer function [symbol] ₓ^{cb2}( ) that produces scalars in the range 1, . . . , l^{ch2}, and has a similar form to the amount and commitment mask scalars.

k_{bxxx,s}^{x2}= [symbol] ₓ^{th2}(“dual-key base”, [symbol] ₓ^{ch1}(rKₖ^{ch1,o}, t))
The output address stored with the output is the sum of normal one-time address and offset. Observers will see a typical one-time address, and not realize there is a secondary authorization key involved.

K_{stored,t}^{ct,o}=Kₜ^{c1,o}+Kₜ^{c1,do}

Now let the receiver search for outputs owned by their dual-key combination.
1. To get access to a dual-key output's normal one-time address, the searcher just needs to subtract the dual-key offset, which they can always recompute (assuming they didn't lose their secondary address).

Kₜ^{ct,o}=K_{xtord,x}−K₈^{ct,do}
2. To search for an owned output, the searcher normally computes (on curve 1) K^{x}=K^{o}− [symbol] ₒ(rK^{x}, t)G and checks K^{x}=K^{x}. However, now the one-time address contains an offset.
   (a) If the offset's base key is G^{x2}, then the searcher can precompute K^{cl,x}+L^{cl,do} before searching since K^{cl,do}=Hₚ(G^{x2}, Kₓ₂^{auth,x}) will be the same between different outputs. For each output, they will check
   (b) If the base key is K_{base,t}²*G^{x2}, then the searcher will have to recompute the offset for every output. They will compute

k_{base,x}²=Hₓ^{ch2}(“dual-key base”, Hₓ^{ch2}(rK_{c}^{ch1,x}, t))

and check

K^{ch,x}=K_{stored,x}^{cl,o-}Hₙ(rK^{ct,v})G^{c1}−Hₚ(k_{base,x}²*G^{x2}, k_{base,x}^{x2}*K_{auth,t}^{t2})

It is slower than the simpler case, but the privacy benefits will be clear as described below.

Finally, after the receiver has identified dual-key outputs that they own, they can spend them. This process for an example embodiment is described below.
1. Begin assembling a normal transaction, with any number of inputs and outputs. At least one input will be spending a dual-key output owned by the author.
2. For each dual-key input, mark it with a ‘type: dual-key authorization’ tag. Include with it the relevant base key (or indicate that it's the generator if applicable), and the secondary authorization shared key. Verifiers can use these to compute the dual-key offset later on. Because the secondary authorization base and shared keys must be explicitly included with transactions, each time the secondary authorization key is reused with the same base key (e.g., the generator) it can be trivially connected to previous similar uses of that key. If the base key is apparently random, as it would be if based on the sender-receiver shared secret (which is different for each output), then each subsequent use of the secondary authorization key will appear independent of earlier uses.
Caveat: If a sender-receiver shared secret is used, then anyone with the recipient's private view key, RingCT address, and secondary authorization address can identify when an output is spent. It is quite different from standard

RingCT, where those with the private view key don't know when an output is spent.

3. Before constructing the dual-key input's MLSAF, aubtract the dual-key offset from each ring member's public key. It's just like how we subtract the pseudo-output commitment from each output commitment. The ring for input j should look like this:

$${ℛ}_{j} = \{ \{ ( \text{?} - {K}_{j}^{c 1 , do} ) , ( {C}_{1 , j} - \text{?} ) \} , \\ … \\ \{ ( \text{?} - {K}_{j}^{c 1 , do} ) , ( \text{?} - \text{?} ) \} , \\ … \\ \{ ( \text{?} - {K}_{j}^{c 1 , do} ) , ( \text{?} - \text{?} ) \} \}$$

$$\text{?} \text{indicates text missing or illegible when filed}$$

The offset is computed with hash-to-point, so its discrete log with respect to the generator Gc¹ is unknown (except with negligible probability), and the output's owner has no choice but to subtract the offset before they can make a signature with the output address. Being forced to subtract the offset means they are also forced to include the real secondary authorization key pair (base and shared) with the transaction, since verifiers need to compute the offset correctly.

However, outputs with offsets appear just like outputs without offsets. Just as the verifier doesn't know which member of a ring signature is the true signer, subtracting the offset from all members leaves him/her just as unaware of the real signer.
4. Include alongside the dual-key input's MLSAF signature and ECDSA signature (signing the same message as the MLSAGs signed) on the secondary authorization shared key, using the secondary authorization base key as ‘generator’, and signing with the private key k_{auth,j}^{x2}. There is no way to trick the verifier into thinking this is a normal transaction, in order to neglect the secondary authorization signature, because to sign to MLSAGs the transaction author was forced to include the secondary key pair in the transaction.

Whoever sends an output to a dual-curve address will know when it is spent, since they can see the output offset in the spending transaction. If the dual-curve address output is a self-spend, then the problem is moot, however more advanced applications of the technique should keep this in mind.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A secure transaction network comprising:
a consensus network;
a ledger; and
a network node in data communication with the consensus network, the ledger, and other network nodes in the secure transaction network via a data network, the network node configured to:
prepare a base cryptocurrency protocol transaction;
generate a transaction output signature (txo-sig) by signing a hash of a source transaction output (source-txo) with a certified hardware security module (HSM) private key;
submit the base cryptocurrency protocol transaction and the txo-sig to a consensus network via the network node of the secure transaction network as a deposit transaction;
create a ristretto point (rptxo) from a hash of an HSM public key, the source-txo, and the txo-sig; and
replace the source-txo with the ristretto point (rptxo) in a ledger of the secure transaction network.

2. The secure transaction network of claim 1 being further configured to generate a random hash value, and then increment the generated hash value until a corresponding curve point is located.

3. The secure transaction network of claim 1 being further configured to use a hash-to-point process to locate a corresponding curve point.

4. The secure transaction network of claim 1 being further configured to implement a withdrawal transaction by matching the HSM public key used for signatures published in the deposit.

5. The secure transaction network of claim 1 being further configured to construct a withdrawal transaction comprising a base cryptocurrency protocol transaction, the original source-txo to be withdrawn, the rptxo that exists in the ledger and a Merkle proof of the existence of the rptxo in the ledger, the HSM public key, new output txos, and a txo-sig signature for each of the new output txos in the withdrawal transaction.

6. The secure transaction network of claim 1 being further configured to assign output spend authority to public keys from different curves.

7. The secure transaction network of claim 1 being further configured to construct a cold storage withdrawal transaction comprising the HSM public key, an old HSM signature, a new HSM signature, and a fake one-time output address for each HSM-secured cold-storage output being spent.

8. The secure transaction network of claim 1 being further configured to generate transaction outputs with a dual-key combination.

9. The secure transaction network of claim 1 being further configured to subtract a dual-key offset from a ring member's public key.

10. The secure transaction network of claim 1 wherein the network node includes an enclave corresponding to a private region of memory.
